(19) United States
(12) Patent Application Publication
(10) Pub. No.: US 2002/0046104 A1
(43) Pub. Date: Apr. 18, 2002

(54) Method and apparatus for generating targeted impressions to internet clients

(75) Inventors: Karim Kaddeche, Santa Ana, CA (US); John Wang, Orange, CA (US)

Correspondence Address: Philip K. Yu, Registered Patent Attorney, 20955 Pathfinder Road, Ste. 160, Diamond Bar, CA, 91765, US

(73) Assignee: Geomicro, Inc.

(21) Appl. No.: 09/851,909

(22) Filed: May 9, 2001

Related U.S. Application Data
(60) Provisional application No. 60/202,572, filed on May 9, 2000.

(51) Int. Cl. G06F 17/60

(52) U.S. Cl. 705/14

(57) ABSTRACT

A method and system of using a server to facilitate a transaction between a subscriber and providers for a right to advertise to the subscriber is disclosed. The server is configured to have access to a profile database storing a set of information regarding the subscriber. The method comprises the steps of connecting the subscriber to the server, generating an identifier to specify the subscriber, retrieving from the profile database at least a set of information regarding the subscriber with the identifier, forwarding the retrieved information to the providers, receiving an offer from the providers, the offer being responsive to the information of the subscriber, accepting an offer from the providers based on given criteria, and forwarding the buyer's advertisement to the subscriber.

### CROSS REFERENCE TO RELATED APPLICATION

This application claims priority from provisional application, Ser. No. 60/202,572, filed May 9, 2000, entitled “METHOD AND SYSTEM FOR IMPROVING INTERNET ADVERTISING EFFECTIVENESS AND REVENUE AND FOR PROVIDING TARGETED INFORMATION TO WIRELESS INTERNET USERS.”

This application also relates to a pending patent application, Ser. No. 09/733,891, filed Dec. 9, 2000, entitled “METHOD AND SYSTEM FOR TARGETING INTERNET ADVERTISEMENTS AND MESSAGES BY GEOGRAPHIC LOCATION.” The disclosure of this related application is incorporated herein by reference.

### RELATED FIELD

The present application is related to the global computer information network, i.e. the Internet and more particularly is related to a highly effective method and system for distributing Internet advertisements to Internet clients.

### ART BACKGROUND

The Internet and high-speed access through personal computers (“PC”) have had a major impact on the economy, on education and even on our personal lives. On the Internet, as with many media, users are exposed to various kinds of advertising, sometimes to their dismay. However, such advertising in reality subsidizes a portion of the cost of making the medium available to its users, i.e. viewers, readers and listeners. Without advertising, daily newspaper would not have cost a quarter. Without advertising, many of the television programs would not have been free to the public.

The Internet and the Worldwide Web (“WWW”) will be no exception to this model, as they become a mainstream medium for information, entertainment and commerce. Many WWW sites derive revenue from embedding advertising within their pages or their services. When an Internet “surfer” views a site's page, he/she will also be presented with a banner ad within the same page. The banner ads are typically sold to advertisers in bulk, in that an advertiser will buy a set number of impressions from the web site. In order to target the impressions, the advertiser relies on the site's aggregate viewer statistics. This statistics-based approach is not the most optimal method of distribution, because many impressions are still being viewed by people who are not likely to respond to them.

Recently, access to the Internet through wireless channels has presented new opportunities for web sites and of course for advertisers. As shown in FIG. 1, a wireless subscriber can access the Internet through the wireless network provisioned by wireless network operators 100 such as AT&T, MCI WorldCom, Pacific Bell, or Sprint. The subscriber's web request is channeled to the Internet through an IP gateway 200. Once into the Internet, the request is forwarded to the requested web site 300, which will reply to the request with the HTML text. In terms of advertisements, the ads may still be embedded within the web page to be viewed by the subscriber, provided that the subscriber's wireless device can effectively display the ad along with the page's content. As with the conventional Internet approach, the ads will not be optimally targeted since their deployment is still based on methodology of their wired Internet counterpart.

By use of the subscriber's location, companies such as GeePS.com, Inc., of Cranbury, N.J., with web site at www.geeps.com, has begun testing of location-based shopping portal in select cities since April 2000. The location of the subscriber is derived from the geographical positioning satellites (“GPS”). When the location of the subscriber is known and communicated to the merchants nearby, advertisements and promotional items can be beamed to the subscriber's wireless device, thus bringing foot traffic to the stores. Without more, such bombardments simply cannot achieve precise targeting and will probably end up annoying the consumers.

Additionally, accessing the web using wireless channels is still at its infancy in terms of how much it costs the consumers to have a reasonable web-enabled wireless device and connection cost, as well how much it costs merchants to begin proliferate their content suitable for wireless access. If wireless communication is going to achieve true convergence with the web, different revenue support model is needed to get more people to use it, more network operators to provide it and more merchants to participate in it.

Therefore, it is desirable to be able to more efficiently target ads to Internet users.

It is also desirable to be able to more efficiently target ads to Internet users, in both wire line and wireless channels.

It is also desirable to be able to derive revenue from the more efficient targeting of ads to offset the cost associated with providing broader Internet access for the public in general.

It is also desirable to have a method and means to arrive at a fair price for each instance of an advertisement without undue burden of human negotiation.

It is further desirable to provide broader access and availability so as to reduce the price barrier for consumers and merchants.

### SUMMARY OF THE PRESENT INVENTION

A method of using a server to facilitate a transaction between a subscriber and providers for a right to advertise to the subscriber is disclosed. The server is configured to have access to a profile database storing a set of information regarding the subscriber. The method comprises the steps of connecting the subscriber to the server, generating an identifier to specify the subscriber, retrieving from the profile database at least a set of information regarding the subscriber with the identifier, forwarding the retrieved information to the providers, receiving an offer from the providers, the offer being responsive to the information of the subscriber, accepting an offer from the providers based on given criteria, and forwarding the buyer's advertisement to the subscriber.

Another aspect of the present invention is a wireless web that can be subsidized by advertising revenue. When a subscriber accesses a web site through a wireless device, the profile information can be released to the web site or advertisers to enable a bidding for the right to make a commercial impression. The information may comprise the subscriber's location, as generated by a GPS receiver on board of the wireless device, or the subscriber's pre-established profile.

### BRIEF DESCRIPTION OF THE DRAWINGS

FIG. 1 is a simplified diagram illustrating the conventional wireless Internet access.

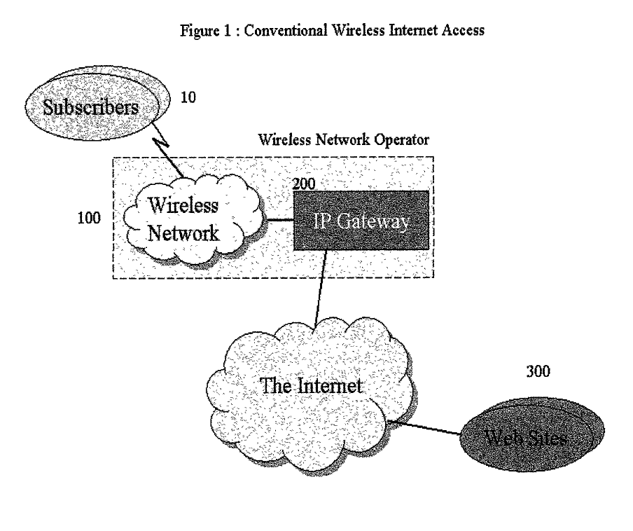

FIG. 2 is a simplified diagram illustrating one embodiment of the present invention.

FIG. 3 is a simplified diagram illustrating another embodiment of the present invention.

### DESCRIPTION OF THE PRESENT INVENTION

The present invention is directed to a method and system for optimally costing and targeting advertising impressions on the Internet. The present invention is also applicable to the growing wireless networks, as will be described herein below. In the description that follows, various terms such as web sites, servers, and databases etc., are used to describe the present invention. These terms are used as they represent how those skilled in the art of the Internet and telecommunications technology ordinarily communicate with each other. Furthermore, although the following description is based on the context of a wireless Internet network, the teaching of the present invention can be readily applied by those skilled in the art to the wired Internet when accessed with personal computers via dial-up modems, television cable modems and DSL.

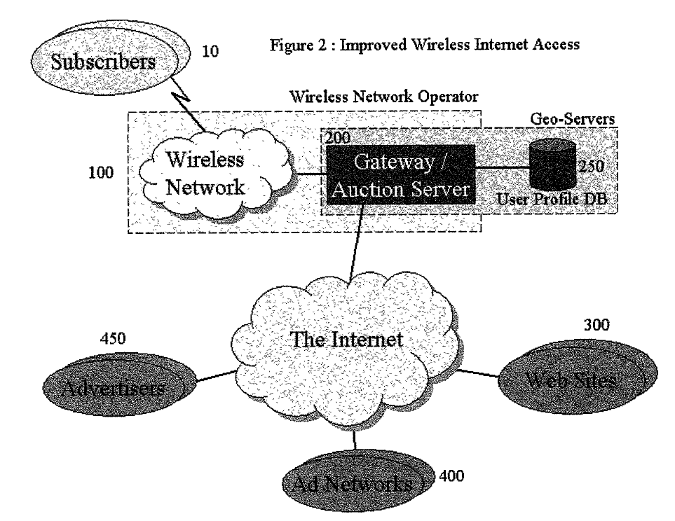

Reference is now turned to FIG. 2. The subscriber 10 may be a consumer with a wireless device that is configured to access the Internet through the wireless networks 100 operated by companies such as AT&T or Sprint. A Gateway and Auction Server 200 is implemented to channel the communication between the subscriber 10 and the requested web sites 300 and the Internet. The Gateway and Auction Server 200 is also linked to a User Profile Database 250. It should be noted that the subscriber's wireless device may include a GPS receiver to provide location information to the network operator 100 when the subscriber activates his/her wireless device. In fact, it is only a matter of time when all wireless or mobile devices in the U.S. be mandated to incorporate a GPS receiver for emergency purposes. The prospect for including GPS receivers is further enhanced by the U.S. Department of Defense decision to stop intentionally degrading the accuracy of civilian GPS transmission, effective May 1, 2000. As will be herein described, the location of the subscriber may be of significant commercial value to location-based merchants and service providers.

The User Profile Databases 250 may be internally compiled by the network operator by combining its own subscriber database with other databases comprising consumer information. Furthermore, the User Profile Databases 250 may be augmented by information provided by the user voluntarily (possibly in exchange for services or goods of value such as additional wireless service, prizes, or coupons for shopping).

The Gateway and Auction Server 200 is configurable to assign each subscriber a unique identity per client/server session in order to enable and maintain a secure communication between the web site server 300 and the subscriber 10. The identity can be assigned at random or may simply be the equipment serial number, a telephone number, or any data string uniquely identifying the subscriber. The Gateway and Auction Server 200 may also be configured to reassign the identity across sessions so that the web site servers 300 can identify the subscribers who have visited the web site before. The same subscriber may be assigned a different identity at each web site he/she visits. The Gateway and Auction Server 200 assigns and maintains the users multiple identities according to company policy that may vary from site to site.

The Gateway and Auction Server 200 may further be configured to simply channel, or release, the identity to the Internet without looking up the user's profile for advertisement or revenue generation purposes. In this sense, this Gateway and Auction Server performs no different from their conventional counterpart.

OPERATION. Conventionally, when a subscriber views a web page on a web site 300 through the wireless network 100, an advertising impression can be inserted on the page, albeit not very targeted. In order to accomplish this insertion in an optimal way in accordance with the present invention, the Gateway/Auction Server 200 looks up the user's profile from the database 250.

The profile is then summarized or extracted in whole or in part based on pre-selected criteria, into a “user profile packet.” This packet may include attributes of the user such as geographic location, age group, sex, income bracket, shopping habits etc. The Auction Server 200 then sends the Packet to several advertisers or advertising networks 400 and 450 simultaneously. Each advertiser will examine the Packet and decide whether to make a bid for the right to make an impression and if so, the price to bid. The advertiser then sends a bid packet back to the Auction Server 200, which chooses the highest bidder and awards the winner the right to make an impression. The bidding process can go on for multiple rounds, provided that a maximum amount of time is not exceeded. The Auction Server 200 then informs the winner and debits the winner's accounts. As can be appreciated by those skilled in the art, this methodology essentially creates an electronic marketplace for the distribution of advertising impressions on the Internet. With advances in high-speed servers, the whole bidding and awarding may take no more than a fraction of a second to conclude.

It is important to note here that this innovation places the burden of determining the cost of an impression on the advertisers who are bidding, but not on the wireless carrier or on the website. To accomplish this task, the advertisers who are bidding are given all the information they need. Since this is highly detailed information about exactly one person, the advertisers can be confident in determining the user's likelihood of response to a particular advertisement. This is in contrast to advertising on other traditional media, or even Internet advertising as practiced today, where the advertiser has to make decisions based on aggregate user statistics.

It should be pointed out that the methodology of the present invention allows multiple bidding actions to occur concurrently. Since the Auction Server can summarize or extract a user's profile, different attributes or packets may be sent to different groups of advertisers or vendors, based on the nature of their businesses.

Also, since the user is not uniquely identified in the bid packet, it would be unlikely for the advertisers to save the user profile and create their own profile data base.

It should be appreciated by those skilled in the art that various components of technology needed for implementation are already in use in the art of wireless communications, B2C and B2B applications, e.g. making wireless transmission of data between subscribers and web sites on the Internet, assigning identifiers to subscribers for each session of wireless communications, storing data on server, making impressions to consumers during web browsing, buying and selling in the aggregate of rights through the Internet, conducting auctions on the Internet, and gathering location data based on GPS information.

FILTERING. The advertisers may apply filters on the user's profile to tell the Auction Server 200 which impressions they what to bid on. Filtering can reduce the bandwidth and computing power needed to send all user impressions to all advertisers. Since most advertisers will be interested in only certain types of user profiles, they can apply the filtering to allow them to bid on opportunities selectively. Bandwidth reduction translates directly into cost savings.

One example of filtering is to use geographic information, e.g. the subscriber's location as determined by the GPS receiver, to only extract those who are within certain distance from a given location. As such, the subscribers who are within the distance of a vendor may get impressions about any promotional items offered by the vendor.

To achieve even more savings in computing time and bandwidth, the right to make impressions may be sold or auctioned off ahead of time, with the buyer earning the right to make impressions to subscribers of certain profile(s) within a given time period, or for a given number of impressions. Given the vibrant economy and diverse demographics in our society, there is always a vendor of goods or services looking for one particular consumer profile. The profile can include categories such as shopping pattern, hobbies and interests, entertainment preferences, fashion inclinations, business affiliation, pleasure, travel, ethnicity, income level or profession. This “pre-sold” inventory can provide a starting price, or baseline, for the real-time dynamic pricing method. In other words, the pre-sold price can be considered a default bid on the impression and can be given a limited preferential treatment. Based on the teaching of the present invention, those skilled in the art of advertising can readily devise many desirable profile categories to exploit the present invention.

Note that any response from the subscriber to the advertisement and the subscriber's general surfing and travel habits can be used to update or modify his/her profile in the Database 250 so as to maintain and enhance the profile's effectiveness.

PRE-PURCHASER. The Gateway/Auction Server 200 can alternatively be configured to cache additional information about the bid and the advertising impression to minimize the amount of data transferred between the advertisers and it self. For example a bid can be marked as valid for multiple impressions with the same or similar profile.

As mentioned earlier, the location of the wireless device and the subscriber, obtained through the GPS receiver, can be a continuously changing part of the user's profile that is released to the advertisers for bidding. For example, if a subscriber is within the neighborhood of several business establishments, e.g. fast food restaurants, bookstores or department stores, the bidding may be conducted to decide which vendor can make the impression. If the time is around mealtime, perhaps the fast food restaurants will have the incentive to earn the right to tell the subscriber the Special of the Day.

Alternatively, the location information may be used in conjunction with the profile in the user profile Database 250 for the advertisers to bid on. The combination of the subscriber's location and his/her shopping pattern may give the department stores an incentive to alert the subscriber to the latest On-Sale items at the store near the subscriber.

PROFILE EXAMPLE. As mentioned before, if the subscriber voluntarily builds her profile in exchange for services, e.g. for free wireless access, the profile may contain information about the subscriber as follows:

Shops at up-scale Department Stores;

Likes Classical music;

Trades stocks on line;

Prefers Asian Restaurants;

Earns more than $100,000 salary;

Has 2 children.

When this subscriber is surfing the Internet using her wireless device, the proxy server can auction off the right to make an impression to the subscriber based on her profile, location or both to the highest bidding advertiser on a real-time basis. For example, if the subscriber is traveling in a neighborhood having the following establishments: Macy's, Burger King, Tower Records and Charles Schwab. When the right to make an impression on this subscriber is up for bids, the advertising agents handling these accounts, or the merchants themselves, may submit their bids to the Gateway/Auction Server. With high-speed servers and Internet connection, the whole process may be resolved in a matter of split seconds. If Charles Schwab wins the bid, the subscriber will have an ad touting Schwab's newest trading services on her wireless device, as well as direction to get to the closest Schwab office.

As can be appreciated by those skilled in the art, all communications between the Internet client's wireless device and any web site are to be routed through the Gateway/Auction Server 200 in order for the operator of the Gateway/Auction Server 200 to collect its fees, which can be used to subsidize the proliferation of wireless web applications.

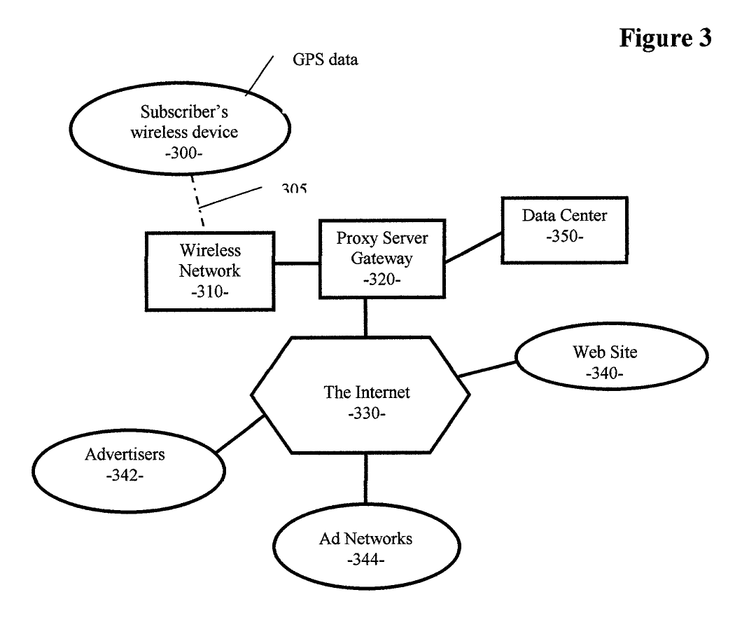

SUBSIDIZED WIRELESS WEB. FIG. 3 shows another embodiment of the present invention, which is directed to providing targeted information to wireless Internet users while providing lower price point for wireless web access. As will be described in the following disclosure, the implementation of the present invention can promote the development of wireless Internet access by rendering the pricing barrier irrelevant. By knocking down the pricing barrier, more wireless web sites and web applications will be available to consumers. And with more consumers, even more web sites and web applications for wireless protocols will be made.

As shown in FIG. 3, a subscriber 300 uses a portable wireless device, which may include a GPS receiver to keep track of the subscriber location, to make a request to a web server 340, i.e. to visit a web site. The request is transmitted through an RF link, i.e. a wireless communications network 305, to a proxy server or gateway 320, which then forwards the request to the web server 340, through the Internet 330. As can be appreciated by those in the wireless art, the wireless network 310 must know which wireless device it is communicating with by assigning an Identity to the wireless device for each session. And the proxy server can be configured to withhold such Identity and location of the subscriber from the web server. The proxy server 320 may be operated by the network operators, such as the MCI, Sprint, AT&T, Verizon Wireless or Pacific Bell, or may be operated by third party service providers affiliated with the network operators.

The proxy server then establishes connection with the requested web server through conventional IP protocol, without having to reveal the Identity and location of the subscriber. The proxy server then returns the requested information to the original subscriber, based on the subscriber's Identity.

It should be noted that many Internet-based services are already provided, free or reduced rate, to the users or visitors because they are subsidized by advertisers, who are willing to pay to make an impression to a web site's visitors. This is done despite the fact that many impressions are made to web visitors at random, without regards to whether the information or advertisement may appeal to the web site's visitors. While advertisement at random is better than no advertisement at all, targeted advertisement to a web site's visitors fitting certain profile is much more effective. If an advertisement can be targeted to specific demographics, e.g. people who enjoy outdoors activities or people who following certain fashion trend, it will be money well-spent. As can be appreciated, advertisers have already been doing such targeted exposure by running ads at the web sites whose visitors fall within certain profile.

This advertisement-subsidy model has been widely used in conventional Internet access based on “wire line” connection. Now, with the teaching of the present invention, this model can be applied to the wireless web access so as to reduce the subscriber's fees associated with wireless web access, while enabling more web sites and advertisements to be targeted by advertisers.

Referring to FIG. 3, the proxy server 320 can release, for a transactional fee, the Identity and/or location of the wireless device, to the web site 340, or advertisers 342, the subscriber is visiting, provided that the subscriber has given permission to the operator of the proxy server, most likely the wireless carrier. Every time the subscriber is connected to the web site, a transactional fee is charged to the web site. The proxy server thus becomes essentially a gatekeeper between the subscriber masses and the hungry web advertisers 342 who have inventories of commercial information to unload.

It should be pointed out that the term “Identity” of the subscriber is not necessarily the identity as to who that subscriber is. The Identity of a wireless subscriber may be a device ID for the wireless device, an equipment serial number (“ESN”), a hardware serial number for the media access (“MAC”), a telephone number, or an alphanumeric string. The Identity is assigned by the proxy server at random when the subscriber communicates with a web publisher. The purpose of the Identity is mainly for the wireless communications network to know with which subscriber it is communicating.

As can be appreciated by those skilled in the art, the Identity is unique per client/server session in order to enable and maintain secured communication between the web publisher and the wireless client. The proxy server may also re-assign the same Identity across sessions such that the web publisher can identify the visitors who have visited the publisher before. However, the same wireless client may be assigned a different identity at each publisher.

With the Identity and location of the subscriber known, the web site can generate more targeted advertisement based on the Identity and/or location of the subscriber. If the location of the subscriber is known, a merchant may want to let the subscriber know that certain promotions are going on at a store near the subscriber's location. If it is around mealtime, Burger King may want to let the subscriber know that a joint is nearby.

PROFILE BUILDING. The Identity of the subscriber also allows the proxy server to build a data center 350, matching the Identity with a profile created by the subscriber, preferably in exchange for free, or reduced-fee, wireless web access. Such profile can be selectively released to the web advertisers 342 for better-targeted advertisements. For example, when a subscriber visits a web site 340 using the subscriber's wireless device, the profile is released, for a fee, to the web site 340 to allow the web site to pick and choose the most suitable advertisement 342 for the known profile.

IMPRESSION AUCTION. The use of Identity, location or profile information can be further enhanced by the proxy server auctioning off, on a real-time basis or pre-determined basis, such information to a network of advertisers 344, for the right to make an impression to the client 300. Such auction can be based on the Identity, location or profile of the subscriber, thus ensuring that the advertisers can optimize their ad revenue.

For example, a subscriber may establish a profile with her wireless carrier, in exchange for free wireless access, as follows:

Shop at Macy's;

Enjoy variety of fast food outlets;

Like Classical music;

Trade stocks on line;

Makes 6-figure salary;

Has 2 school-aged children.

When this subscriber is browsing the Internet using her wireless device, the proxy server can auction off the right to make an impression to the subscriber based on her profile, location, or both, to the highest bidding advertiser on a real-time basis. For example, if the subscriber is traveling in a neighborhood having the following establishments: Macy's, Burger King, Tower Records and Charles Schwab. When the right to make an impression on this subscriber is up for bids, the advertising agents handling these accounts may bid through their networks. With high-speed servers and the Internet connection, the whole process may be resolved in a matter of split seconds, especially if such process is automated. If Charles Schwab's agent wins the bid, the subscriber will have an ad touting Schwab's newest trading services on her wireless device, as well as direction to get to a Schwab office.

As described herein, the proxy server may also pre-sell, whether through an auction process or not, the right to make impressions to subscribers fitting certain profiles and/or near certain locations, in bulk. For example, the operator of the proxy server may pre-sell the right to make impressions to a group of subscribers who eat out frequently to the advertiser handling Coco's account. When such subscribers get on-line using their wireless devices, the proxy server automatically link Coco's latest special menu to the wireless device. Also, if one subscriber happens to be within the neighborhood of a Coco's restaurant while browsing the Internet around mealtime, a message regarding that day's special may also be provided to the subscriber.

As can be appreciated by those skilled in the art, all communications between the Internet client's device and any web site are to go through the proxy server or gateway in order for the operator of the proxy server to collect its fees, which can be used to subsidize the proliferation of wireless web applications.

COMPARISON-SHOPPING. To further exploit the power of wireless web access, the proxy server may be configured to search the web to help a subscriber do comparison-shopping. The subscriber first enters a merchandize she has in mind to the wireless device, either through manual entry or by scanning the bar code, e.g. SKU number, of an item on the shelf, provided that there is a bar code reader incorporated with the wireless device. Upon receiving the product number that identifies an item, the proxy server searches the web to find the businesses that carry items matching such product number within a subscriber-defined region. Such information may be communicated to the subscriber instantly such that the subscriber can decide whether to purchase such product right there, or go to another store if the difference is substantial.

Again, this model can be subsidized by those merchants willing to have their prices compared. The more merchants who participate in this product price auctioning, the more subsidies there are for the carrier to offer wireless web access to broader demographics.

PHYSICAL REALIZATION. The present invention can be physically realized as follows. For the subscriber 300, a device integrating a GPS receiver, an optional bar-code reader, and wireless transmitter/receiver can be used. The wireless transmission can be based on CDMA, GSM or CDPD etc. The wireless device can either be stand alone, or an add-on to a Personal Digital Assistant, such as a Palm Pilot, Visor, Pocket PC etc. The device can transmit its location to the proxy server. Of course, there is also the wireless network 310, such as Nextel, AT&T Wireless, or Sprint.

As shown in FIG. 3, a proxy server, or gateway, 320 that facilitates communications between the subscribers and wireless web publishers, or web sites. The proxy server has the capability to assign each subscribe an Identity and either withhold, or release such Identity to the web sites.

A data center 350 can be created to establish subscriber profiles. The data center can also help auction or pre-sell right to make impressions to subscribers to advertisement agents, based on the subscribers' profiles, locations or Identities.

The present invention may be embodied in other specific forms without departing from the spirit or essential characteristics thereof. The present embodiments are to be considered in all respects as illustrative, and not restrictive. The scope of the invention is therefore, indicated by the appended claims rather than by the foregoing description, and all changes which come within the meaning and range of equivalency of the claims are to be embraced within their scope.

We claim:

1. A method of using a server to facilitate a transaction between a subscriber and at least one provider for a right to advertise to the subscriber, the server being configured to have access to a profile database storing a predetermined set of information regarding the subscriber, comprising the steps of:
(a) connecting the subscriber to the server;
(b) generating an identifier to specify the subscriber;
(c) retrieving from the profile database at least a portion of the predetermined set of information regarding the subscriber with the identifier;
(d) forwarding the retrieved information to said at least one provider;
(e) receiving an offer from said at least one provider, the offer being responsive to the information of the subscriber;
(f) accepting said offer from said at least one provider based on predetermined criteria;
(g) forwarding the buyer's advertisement to the subscriber.

2. The method according to claim 1, wherein said information comprises geographical location of the Internet client.

3. The method according to claim 1, wherein the predetermined criteria comprise at least one of the following:
(a) the offer being the first to reply among all offers;
(b) the offer being the highest among all offers.

4. A method for using a server to provide targeted impression to an Internet client, the Internet client accessing the Internet through a wireless network and the server, the server being configured to have access to a profile database storing profile information regarding the Internet client, comprising:
(a) connecting the Internet client to the server through the wireless network;
(b) generating an identifier to describe the Internet client;
(c) retrieving, from the profile database, profile information regarding the Internet client with the identifier;
(d) forwarding the profile information to a plurality of impression providers;
(e) receiving at least one offer from a plurality of impression providers for a right to make at least one impression to the Internet client;
(f) selecting an offer based on predetermined criteria;
(g) forwarding the impression from one of said providers to the Internet client.

5. The method of claim 4, further comprising a step of filtering at least a subset of the profile information based on predetermined criteria during the step of retrieval.

6. The method of claim 5, wherein said profile information retrieved comprises geographical information of the Internet client.

7. The method according to claim 5, wherein the predetermined criteria in Step d) are specified by the impression providers.

8. The method according to claim 5, wherein the predetermined criteria in Step d) are specified by the Internet client.

9. A method for using a server to provide targeted impression to an Internet client, the Internet client accessing the Internet through a wireless network and the server, the server being configured to have access to a profile database storing profile information regarding the Internet client, comprising:
(a) connecting the Internet client to the server through the wireless network;
(b) generating an identifier to specify the Internet client;
(c) retrieving, from the profile database, profile information regarding the Internet client with the identifier;
(d) determining whether at least a subset of the Internet client's profile information is already reserved by a predetermined impression provider, and if so, forwarding the provider's impression to the Internet client;
(e) and if not reserved, forwarding the profile information to a plurality of impression providers;
(f) receiving at least one offer from a plurality of impression providers for a right to make at least one impression to the Internet client;
(g) selecting an offer based on predetermined criteria;
(h) forwarding the impression from the winning provider to the Internet client.

10. The method according to claim 9, wherein the information retrieved from the profile database comprises geographical location of said Internet client.

11. The method according to claim 9, further comprising:
(a) the server monitoring the Internet client's response to the impression;
(b) the server modifying the profile database for the Internet client based on the Internet client's response to the impression.

12. The method according to claim 9, further comprising:
(a) the server caching impressions supplied by a plurality of impression providers;
(b) the server forwarding one of the impressions to the Internet client upon a successful bidding by one of the impression providers.

13. The method according to claim 9, further comprising:
(a) the server caching impressions supplied by a plurality of impression providers;
(b) the server also caching standing bids reserved by the impression providers, the standing bids being reviewed when the retrieved user profile for the Internet client matches a predetermined set of criteria;
(c) the server determining which one of the standing bids is to be invoked;
(d) the server forwarding one of the cached impressions to the Internet client upon the standing bid.
